(19) United States
(12) Patent Application Publication
(10) Pub. No.: US 2004/0266332 A1
(43) Pub. Date: Dec. 30, 2004

(54) Communication methods and apparatus

(76) Inventor: Jack Arnold Lang, Cambridgeshire (GB)

Correspondence Address: DORSEY & WHITNEY LLP, 1001 PENNSYLVANIA AVENUE, N.W., SUITE 400 SOUTH, WASHINGTON, DC, 20004, US

(21) Appl. No.: 10/475,758

(22) PCT Filed: Sep. 24, 2003
(86) PCT No.: PCT/GB03/04085

(30) Foreign Application Priority Data
Oct. 2, 2002 (GB) 02228286
Nov. 4, 2002 (GB) 02256535

(51) Int. Cl. H04H 1/00

(52) U.S. Cl. 455/3.01

(57) ABSTRACT

This invention generally relates to ultra wideband (UWB) communication, and in particular to methods and apparatus for enabling such communication.

There is described a method of distributing an uiltrawideband (UWB) communications signal through a building, the method comprising generating a UWB signal and coupling the UWB signal to at least one electrical conductor of a mains power supply circuit of the building to distribute the UWB signal. This facilitates implementation of a UWB network with reduced interference.

This invention generally relates to ultra wideband (UWB) communication, and in particular to methods and apparatus for enabling such communication.

Techniques for UWB communication developed from radar and other military applications, and pioneering work was carried out by Dr G. F. Ross, as described in U.S. Pat. No. 3,728,632. Ultra-wideband communications systems employ very short pulses of electromagnetic radiation (impulses) with short rise and fall times, resulting in a spectrum with a very wide bandwidth. Some systems employ direct excitation of an antenna with such a pulse which then radiates with its characteristic impulse or step response (depending upon the excitation). Such systems are referred to as “carrier free” since the resulting rf emission lacks any well-defined carrier frequency. However other UWB systems radiate one or a few cycles of a high frequency carrier and thus it is possible to define a meaningful centre frequency and/or phase despite the large signal bandwidth. The US Federal Communications Commission (FCC) defines UWB as a −10 dB bandwidth of at least 25% of a centre (or average) frequency or a bandwidth of at least 1.5 GHz; the US DARPA definition is similar but refers to a −20 dB bandwidth. Such formal definitions are useful and clearly differentiates UWB systems from conventional narrow and wideband systems but the techniques described in this specification are not limited to systems falling within this precise definition and may be employed with similar systems employing very short pulses of electromagnetic radiation.

UWB communications systems have a number of advantages over conventional systems. Broadly speaking, the very large bandwidth facilitates very high data rate communications and since pulses of radiation are employed the average transmit power (and also power consumption) may be kept low even though the power in each pulse may be relatively large. Also, since the power in each pulse is spread over a large bandwidth the power per unit frequency may be very low indeed, allowing UWB systems to coexist with other spectrum users and, in military applications, providing a low probability of intercept. The short pulses also make UWB communications systems relatively unsusceptible to multipath effects since multiple reflections can in general be resolved. Finally UWB systems lend themselves to a substantially all-digital implementation, with consequent cost savings and other advantages.

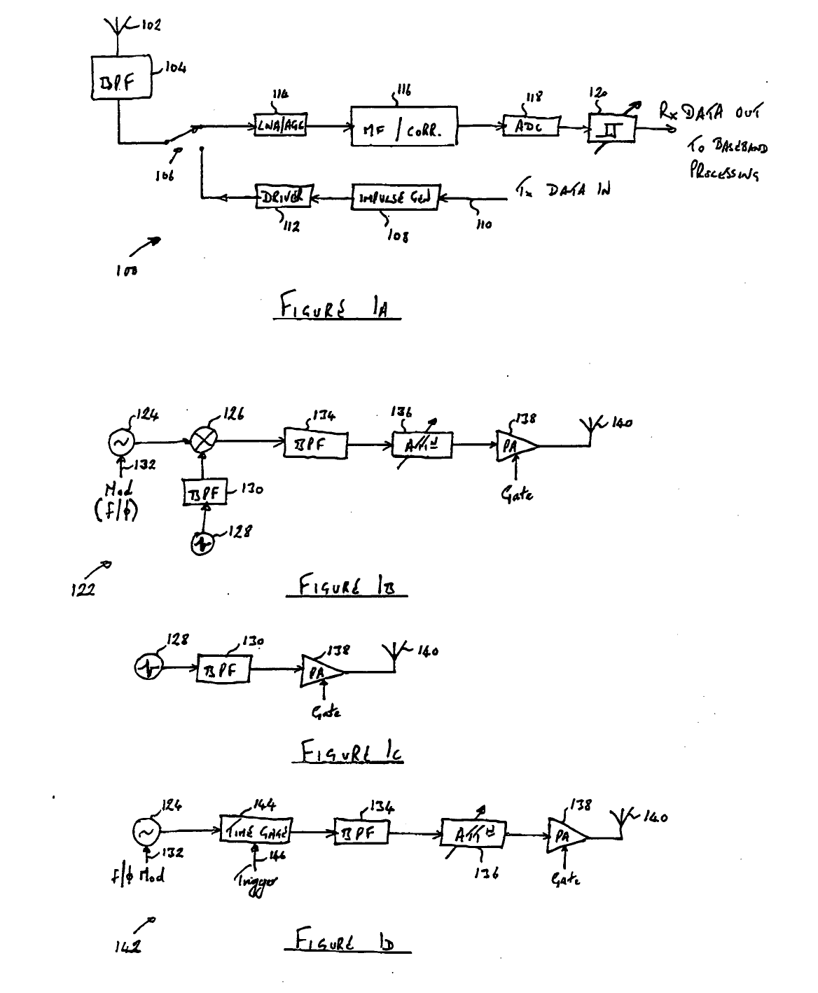

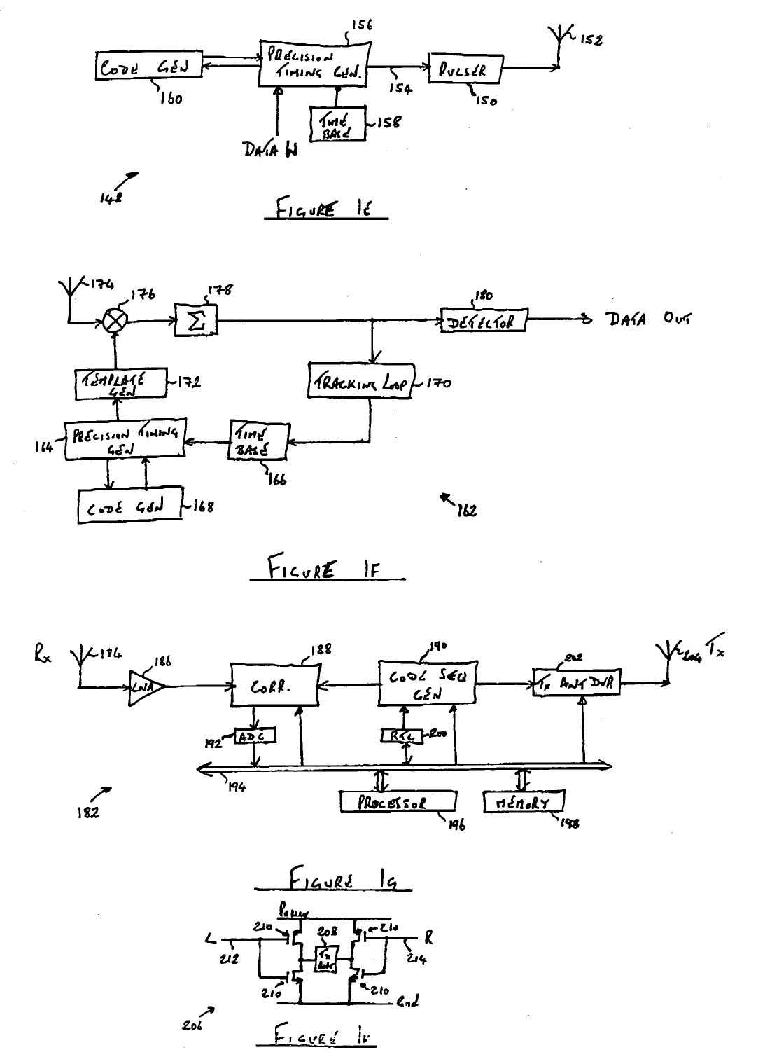

FIG. 1a shows a typical UWB transceiver 100. This comprises an transmit/receive antenna 102 with a characteristic impulse response indicated by bandpass filter (BPF) 104 (although in some instances a bandpass filter may be explicitly included), couples to a transmit/receive switch 106.

The transmit chain comprises an impulse generator 108 modulatable by a baseband transmit data input 110, and an antenna driver 112. The driver may be omitted since only a small output voltage swing is generally required. One of a number of modulation techniques may be employed, typically either OOK (on-off keying ie. transmitting or not transmitting a pulse), M-ary amplitude shift keying (pulse amplitude modulation), or PPM (pulse position modulation ie. dithering the pulse position). Typically the transmitted pulse has a duration of <1 ns and may have a bandwidth of the order of gigahertz.

The receive chain typically comprises a low noise amplifier (LNA) and automatic gain control (AGC) stage 114 followed by a correlator or matched filter (MF) 116, matched to the received pulse shape so that it outputs an impulse when presented with rf energy having the correct (matching) pulse shape. The output of MF 116 is generally digitised by an analogue-to-digital convertor (ADC) 118 and then presented to a (digital or software-based) variable gain threshold circuit 120, the output of which comprises the received data. The skilled person will understand that forward error correction (FEC) such as block error coding and other baseband processing may also be employed, but such techniques are well-known and conventional and hence these is omitted for clarity.

FIG. 1b shows one example of a carrier-based UWB transmitter 122, as described in more detail in U.S. Pat. No. 6,026,125 (hereby incorporated by reference). This form of transmitter allows the UWB transmission centre frequency and bandwidth to be controlled and, because it is carrier-based, allows the use of frequency and phase as well as amplitude and position modulation. Thus, for example, QAM (quadrature amplitude modulation) or M-ary PSK (phase shift keying) may be employed.

Referring to FIG. 1b, an oscillator 124 generates a high frequency carrier which is gated by a mixer 126 which, in effect, acts as a high speed switch. A second input to the mixer is provided by an impulse generator 128, filtered by an (optional) bandpass filter 130. The amplitude of the filtered impulse determines the time for which the mixer diodes are forward biased and hence the effective pulse width and bandwidth of the UWB signal at the output of the mixer. The bandwidth of the UWB signal is similarly also determined by the bandwidth of filter 130. The centre frequency and instantaneous phase of the UWB signal is determined by oscillator 124, and may be modulated by a data input 132. An example of a transmitter with a centre frequency of 1.5 GHz and a bandwidth of 400 MHz is described in U.S. Pat. No. 6,026,125. Pulse to pulse coherency can be achieved by phase locking the impulse generator to the oscillator.

The output of mixer 126 is processed by a bandpass filter 134 to reject out-of-band frequencies and undesirable mixer products, optionally attenuated by a digitally controlled rf attenuator 136 to allow additional amplitude modulation and then passed to a wideband power amplifier 138 such as a MMIC (monolithic microwave integrated circuit), and transmit antenna 140. The power amplifier may be gated on and off in synchrony with the impulses from generator 128, as described in US '125, to reduce power consumption.

FIG. 1c shows a similar transmitter to that of FIG. 1b, in which like elements have like reference numerals. The transmitter of FIG. 1c is, broadly speaking, a special case of the transmitter of FIG. 1b in which the oscillator frequency has been set to zero. The output of oscillator 124 of FIG. 1b is effectively a dc level which serves to keep mixer 126 always on, so these elements are omitted (and the impulse generator or its output is modulated).

FIG. 1d shows an alternative carrier-based UWB transmitter 142, also described in U.S. Pat. No. 6,026,125. Again like elements to those of FIG. 1b are shown by like reference numerals.

In the arrangement of FIG. 1d a time gating circuit 144 gates the output of oscillator 124 under control of a timing signal 146. The pulse width of this timing signal determines the instantaneous UWB signal bandwidth. Thus the transmitted signal UWB bandwidth may be adjusted by adjusting the width of this pulse.

Ultra-wideband receivers suitable for use with the UWB transmitters of FIG. 1b to 1d are described in U.S. Pat. No. 5,901,172. These receivers use tunnel diode-based detectors to enable single pulse detection at high speeds (several megabits per second) with reduced vulnerability to in-band interference. Broadly speaking a tunnel diode is switched between active and inactive modes, charge stored in the diode being discharged during its inactive mode. The tunnel diode acts, in effect, as a time-gated matched filter, and the correlation operation is synchronised to the incoming pulses.

FIG. 1e shows another example of a known UWB transmitter 148, as described for example in U.S. Pat. No. 6,304,623 (hereby incorporated by reference). In FIG. 1e a pulser 150 generates an rf pulse for transmission by antenna 152 under control of a timing signal 154 provided by a precision timing generator 156, itself controlled by a stable timebase 158. A code generator 160 receives a reference clock from the timing generator and provides pseudo-random time offset commands to the timing generator for dithering the transmitter pulse positions. This has the effect of spreading and flattening the comb-like spectrum which would otherwise be produced by regular, narrow pulses (in some systems amplitude modulation may be employed for a similar effect).

FIG. 1f shows a corresponding receiver 162, also described in US '623. This uses a similar timing generator 164, timebase 166 and code generator 168 (generating the same pseudo-random sequence), but the timebase 166 is locked to the received signal by a tracking loop filter 170. The timing signal output of timing generator 164 drives a template generator 172 which outputs a template signal matching the transmitted UWB signal received by a receive antenna 174. A correlator/sampler 176 and accumulator 178 samples and correlates the received signal with the template, integrating over an aperture time of the correlator to produce an output which at the end of an integration cycle is compared with a reference by a detector 180 to determine whether a one or a zero has been received.

FIG. 1g shows a known UWB transceiver 182 employing spread spectrum techniques and thus facilitating, for example, the co-existence of UWB communications systems and hence the unplanned deployment of UWB networks in domestic dwellings. The transceiver of FIG. 1g is described in more detail in U.S. Pat. No. 6,400,754 the contents of which are hereby explicitly incorporated by reference.

In FIG. 1g a receive antenna 184 and low noise amplifier 186 provide one input to a time-integrating correlator 188. A second input to the correlator is provided by a code sequence generator 190 which generates a spread spectrum-type code such as a Kasami code, that is a code with a high auto-correlation coefficient from a family of codes with no low cross-correlation coefficients. Correlator 188 multiplies the analogue input signal by the reference code and integrates over a code sequence period and in US '754 is a matched filter with a plurality of phases representing different time alignments of the input signal and reference code. The correlator output is digitised by analogue-to-digital converter 192 which provides an) output to a bus 194 controlled by a processor 196 with memory 198 the code sequence generator 190 is driven by a crystal oscillator driven flock 200 a transmit antenna driver 202 receives data from bus 194 which is multiplied by a code sequence from generator 190 and transmitted from transmit antenna 204.

In operation coded sequences of impulse doublets are received and transmitted, in one embodiment each bit comprising a 1023-chip sequence of 10 ns chips and thus having a duration of 10 μs. This provides 30 dB processing gain and reduces interference between clusters of network nodes which are not exactly synchronised to one another. Within a cluster employing the same CDMA (Code Division Multiple Access) code, Time Division Multiple Access (TDMA) is employed. The skilled person will recognise that shorter spreading sequences and/or faster clocks may be employed for higher bit rates.

The transceiver described in US '754 uses a modification of a frequency-independent current-mode shielded loop antenna (as described in U.S. Pat. No. 4,506,267) comprising a flat rectangular conducting plate. This antenna is referred to as a large-current radiator (LCR) antenna and when driven by a current it radiates outwards on the surface of the plate.

FIG. 1h shows a driver circuit 206 for such an LCR transmit antenna 208. The antenna is driven by an H-bridge comprising four MOSFETs 210 controlled by left (L) and right (R) control lines 212, 214. By toggling line 214 high then low whilst maintaining line 214 low an impulse doublet (that is a pair of impulses of opposite polarity) of a first polarity is transmitted, and by toggling line 212 high then low whilst holding line 214 low an impulse doublet of opposite polarity is radiated. The antenna only radiates whilst the current through it changes, and transmits a single gaussain impulse on each transition.

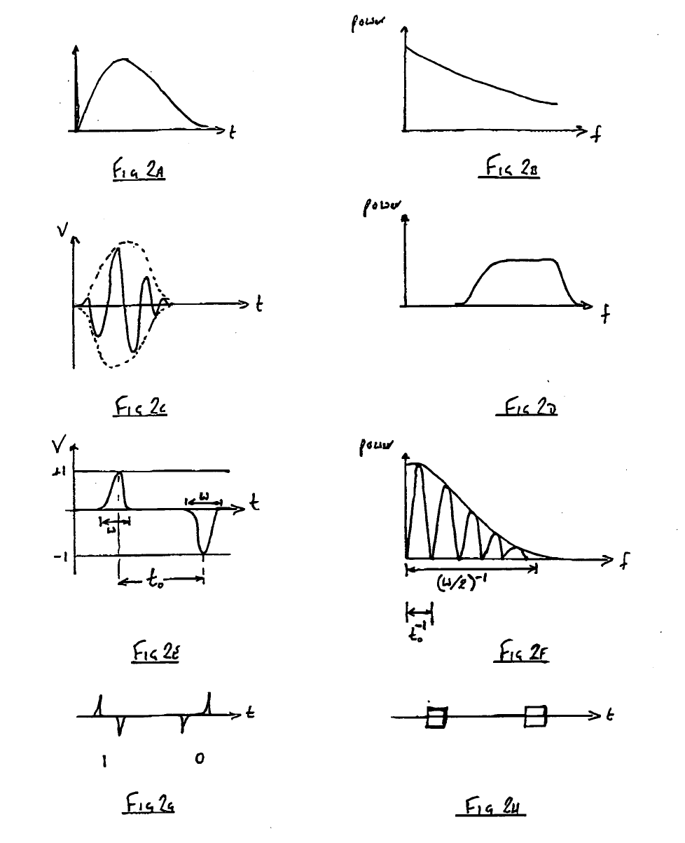

FIG. 2a to 2h show examples UWB waveforms. FIG. 2a shows a typical output waveform of a UWB impulse transmitter, and FIG. 1b shows the power spectrum of the waveform of FIG. 2a FIG. 2c shows a wave-look pulse (which when shortened becomes a monocycle) such as might be radiated from one of the transmitters of FIG. 1b to 1d. FIG. 2d shows the power spectrum of FIG. 2c. FIG. 2e shows an impulse doublet and FIG. 2f the power spectrum of the doublet of FIG. 2e. It can be seen that the spectrum of FIG. 2f comprises a comb with a spacing (in frequency) determined by the spacing (in time) of the impulses of the doublet and an overall bandwidth determined by the width of each impulse. It can also be appreciated from FIGS. 2e and 2f that dithering the pulse positions will tend to reduce the nulls of the comb spectrum. FIG. 2g shows examples of basis impulse doublet waveforms for a logic 0 and a logic 1. FIG. 2h shows an example of a TDMA UWB transmission such as might be radiated from the transceiver of FIG. 1g, in which bursts of CDMA-encoded data are separated by periods of non-transmission to allow access by other devices.

Ultrawide band potentially offers significant advantages for wireless home networking, particularly broadband networking for audio and video entertainment devices. However the wide bandwidth of UWB communications is causing concern, particularly in relation to possible interference with GPS (Global Positioning System) and Avionics Systems. For this reason although use of UWB has recently been approved by the FCC in the US, operation is only permitted at very low powers and over a restricted bandwidth (3.1 to 10.6 GHz). There is therefore a need for methods and apparatus to facilitate UWB communications at low powers, particularly in the home.

According to a first aspect of the present invention there is therefore provided a method of distributing an ultrawideband (UWB) communications signal through a building, the method comprising generating a UWB signal; and coupling the UWB signal to at least one electrical conductor of a mains power supply circuit of the building to distribute the UWB signal.

Distributing the UWB signal over the mains power supply of a building such as a domestic dwelling, for example a house or flat, and potentially enables increased UWB communication range and/or reduced power for a desired range. Furthermore because UWB signals propagate relatively poorly through building walls the method potentially enables the use of higher average UWB radiated power without a correspondingly increased risk of causing interference.

A single UWB transmitter may be employed, for example at a point of mains ingress into the building but the method preferably comprises generating a plurality of UWB signals at a plurality of UWB transmitters and coupling these onto the mains supply at different points within the building. It is further preferable that a common timing is established between at least a subset of the UWB signals, for example between all the transmitters within a room. This helps to reduce interference and facilitates multiple access techniques such as TDMA. A common or consensus clock may be established between all transmitters in the building using the mains supply as a shared communications medium or, alternatively, clusters of transmitters may be established with a common or consensus clock and CDMA techniques used to reduce interference between such clusters. (It will be appreciated that establishing a common timing does not require that transmitters transmit impulses at the same time).

Additionally or alternatively to establishing a common timing store-and-forward nodes may be employed so that data may be transmitted in a series of hops from one transceiver to another. Multiple transmitters and receivers equipped with storage may be configured as a mesh of store-and-forward nodes.

The UWB signal may be coupled onto the mains power supply by means of a capacitative coupling to one or more of the electrical conductors, for example to a live conductor and/or to a neutral conductor. In some buildings with a wired earth

According to a first aspect of the present invention there is therefore provided a method of distributing an ultrawideband (UWB) communications signal through a building, the method comprising generating a UWB signal; and coupling the UWB signal to at least one electrical conductor of a mains power supply circuit of the building to distribute the UWB signal.

Distributing the UWB signal over the mains power supply of a building such as a domestic dwelling, for example a house or flat, and potentially enables increased UWB communication range and/or reduced power for a desired range. Furthermore because UWB signals propagate relatively poorly through building walls the method potentially enables the use of higher average UWB radiated power without a correspondingly increased risk of causing interference.

A single UWB transmitter may be employed, for example at a point of mains ingress into the building but the method preferably comprises generating a plurality of UWB signals at a plurality of UWB transmitters and coupling these onto the mains supply at different points within the building. It is further preferable that a common timing is established between at least a subset of the UWB signals, for example between all the transmitters within a room. This helps to reduce interference and facilitates multiple access techniques such as TDMA. A common or consensus clock may be established between all transmitters in the building using the mains supply as a shared communications medium or, alternatively, clusters of transmitters may be established with a common or consensus clock and CDMA techniques used to reduce interference between such clusters. (It will be appreciated that establishing a common timing does not require that transmitters transmit impulses at the same time).

Additionally or alternatively to establishing a common timing store-and-forward nodes may be employed so that data may be transmitted in a series of hops from one transceiver to another. Multiple transmitters and receivers equipped with storage may be configured as a mesh of store-and-forward nodes.

The UWB signal may be coupled onto the mains power supply by means of a capacitative coupling to one or more of the electrical conductors, for example to a live conductor and/or to a neutral conductor. In some buildings with a wired earth connection to the mains power socket the earth wire may additionally or alternatively be used to distribute UWB signals depending upon the impedance of the earth connection to ground at the frequencies of interest. In some embodiments the UWB signal may be driven differentially onto two conductors of the mains power supply circuit and/or a single-ended or differential current drive may be employed.

One or more of the centre frequency and bandwidth of the UWB signal may be adjusted to suppress interference from other devices connected to the mains supply in the building, such as electric motors. Additionally or alternatively timing of UWB pulses may be varied to reduce the vulnerability of the UWB signals to interference. Similar techniques may be employed, if necessary, to reduce interference caused by the UWB signal or signals.

In another aspect the invention provides a data communications network, such as a packet data communications network, configured to use the above-described method.

The invention further provides apparatus for distributing an ultrawideband (UWB) communications signal through a building, the apparatus comprising means for generating a UWB signal; and means for coupling the UWB signal to at least one electrical conductor of a mains power supply circuit of the building to distribute the UWB signal.

The above-described apparatus may be incorporated in a consumer electronics device, in particular a mains powered consumer electronics device.

These and other aspects of the invention will now be further described, by way of example only, with reference to the accompanying figures in which:

FIG. 1a to 1h show, respectively, a typical UWB transceiver, a first example of a known carrier-based UWB transmitter, a variant of this first example transmitter, a second example of a known carrier-based UWB transmitter, a third example of a known UWB transmitter, a receiver for the third example transmitter, a known UWB transceiver employing spread spectrum techniques, and a driver circuit for a large-current radiator antenna;

FIG. 2a to 2h show examples of UWB waveforms;

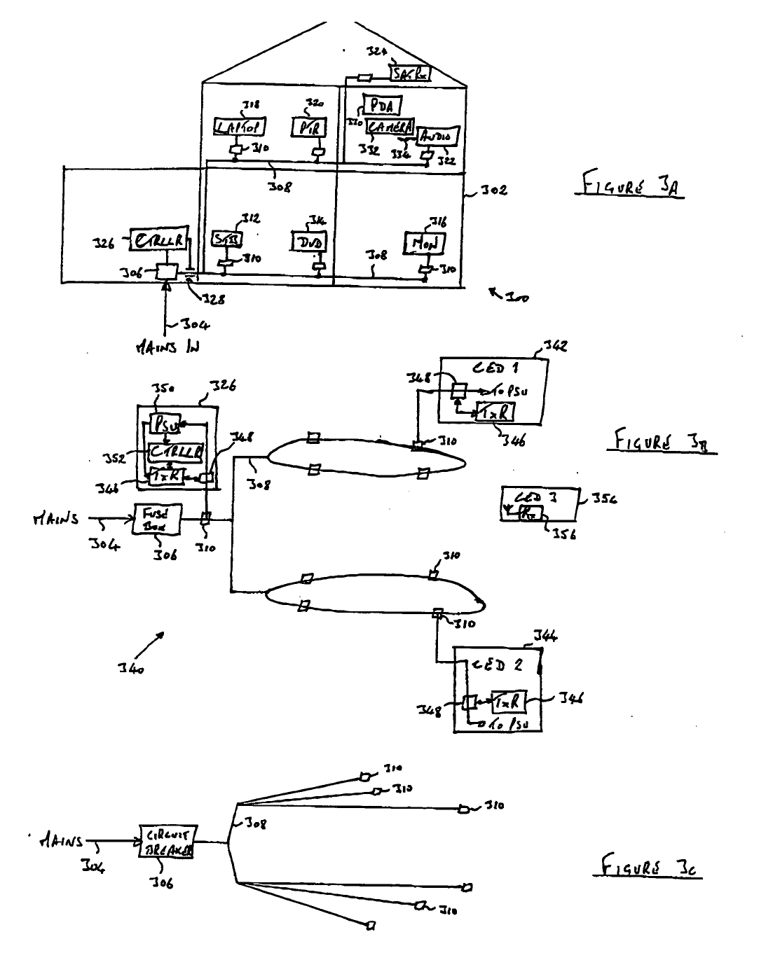

FIG. 3a to 3c show, respectively, a UWB home wireless network, a ring mains based UWB home network, and an alternative mains power distribution wiring configuration; and

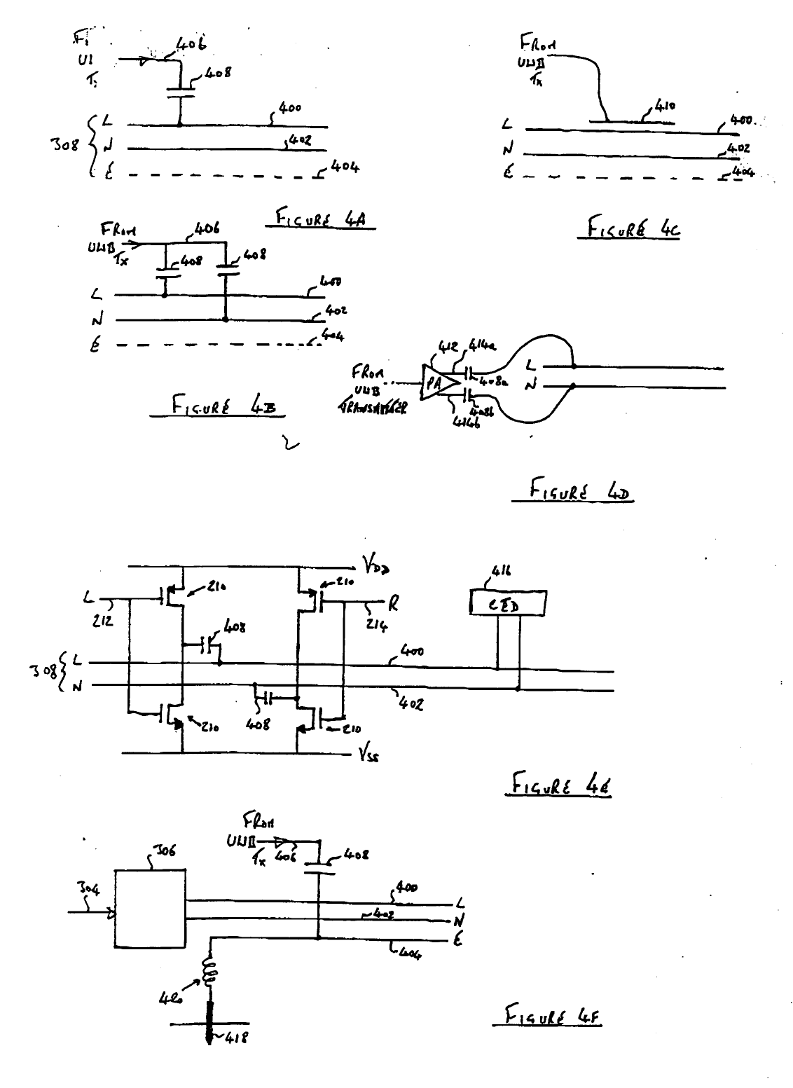

FIG. 4a to 4f show alternatives for coupling a UWB transmitter to mains wiring.

Referring now to FIG. 3a, this shows a UWB home wireless network 300 employing mains power supply wiring as a transmission medium. A home 302 has an incoming mains power supply 304 coupled via a fuse box 306 to a ring or spur-based mains power distribution circuit 308 with a plurality of mains power sockets 310. One or more consumer electronics devices (CEDs) are plugged into each of the sockets, in the illustrated example these including a set top box (STB) 312, a DVD player 314, a TV or computer monitor 316, a laptop computer 318, a printer 320, an audio system 322, and a satellite receiver 324. One or more of these devices may be equipped with a UWB transmitter, receiver, or transceiver for communicating with others of the devices or with a controller 326 connected to the fuse box 306. These UWB devices are rf coupled to mains circuit 308 via power sockets 310 and, in the case of controller 326, fuse box 306. Additional coupling such as coupling 328 of controller 326 may also optionally be employed. Fuse box 306 may incorporate a UWB filter to reduce external interference and to limit egress of UWB transmissions from house 302.

Free space transmitted power falls off with distance to the power of −2, but through-wall transmissions typically fall off faster, with an exponent of between −3 and −4. Coupling the UWB transmitters of a consumer electronic device to the mains circuit facilitates UWB-based networking between the devices by providing improved propagation, for example between devices separated by a wall. For example, UWB propagation ranges of greater than 10 m may be achieved in mains wiring.

The use of UWB communications particularly facilitates high bit rate data links such as audio, and particularly video data links. Devices such as personal digital assistants (PDA) 330 and camera 332 which are not directly connected to the mains circuit 308 may communicate with a mains powered and UWB-enabled device such as audio system 322, for example via a Bluetooth link 334 and thus obtain access to mains cabling-facilitated UWB transmitter and/or receiver equipment.

Referring now to FIG. 3b, this shows an example of a ring mains based UWB home network 340, in which like elements to those of FIG. 3a are indicated by like reference numerals.

In FIG. 3b two mains powered consumer electronic devices 342, 344 are shown each having a mains input connected to an internal power supply unit for supplying internal DC power to elements of the device and also to a UWB transceiver 346 coupled to the mains input by coupling means 348. The controller 326 is similar, and includes the mains driven power supply 350 and a network controller 352 to, for example, to control time and/or frequency domain access to a part or all of the network for the transmitters of transceivers 346.

A battery powered consumer electronics device 354 includes a UWB receiver 356 and, optionally, a UWB transmitter (not shown). Device 354 can receive UWB signals radiated from mains power lines and, since it lacks direct access to mains wiring-facilitated UWB signal propagation, it may transmit via an intermediary such as one of devices 342, 344 or controller 326. Alternatively UWB transmissions from device 354 may couple wirelessly into the mains wiring.

FIG. 3c shows an alternative mains power distribution wiring configuration to which the techniques described herein can also be applied. In FIG. 3c like elements to those of FIGS. 3b and 3a are indicated by like reference numerals.

FIG. 4a to 4f show alternatives for coupling a UWB transmitter to mains wiring.

Referring to FIG. 4a, mains wiring generally comprises a pair of conductors 400, 402 for respective live and neutral connections and, optionally, a third conductor 404 to provide an earth connection. An output 406 from a UWB transmitter normally provided to a transmit antenna may instead be coupled to either or both of live and neutral conductors 400, 402 via a coupling capacitor 408. FIG. 4b illustrate coupling to both live and neutral conductors via a pair of capacitors 408. Line 406 may, for example, comprise an output of power amplifier 138 of the titter of FIG. 1b, 1c or 1d. Coupling capacitor 408 is chosen to have a high impedance at mains frequencies but a low impedance at the relatively high frequencies used for UWB transmissions, that is a relatively high impedance around 50 Hz and a low impedance above, for example, 1 GHz. A discrete component with a value of, say, 1 nF may be employed but, in practice, capacitor 408 need not be a lumped element and may simply comprise the capacitants between a coupling conductor 410 and one or more of the mains power conductors, as shown in FIG. 4c. Alternatively a UWB transmitter with an output amplifier 412 providing a differential voltage or current output 414a, b may be employed with twin coupling capacitors 408a, b as shown in FIG. 4d. The conductors of the mains power supply act, to some extent, as a leaky transmission line, particularly where the conductors are twisted, and thus the rf energy tends to propagate a long space between the conductors, albeit leaking out from around the conductors to provide a relatively increased power but localised electromagnetic field.

FIG. 4e shows a further alternative arrangement for coupling a UWB transmission to a pair of mains power conductors, based upon the circuit of FIG. 1h as described in U.S. Pat. No. 6,400,754, which circuit is specifically hereby incorporated by reference. In FIG. 4e the “H-drive” from FETs 210 is applied via coupling capacitors 408 to live and neutral mains conductors 400, 402 to provide a current drive to the mains power wiring. Current flows through capacitors 408 and mains conductors 400, 402 and also through consumer electronics device 416 plugged into the mains supply) forming a circuit. It will be appreciated that because of the presence of doubling capacitors 408 current will only flow during transitions where one or other of control lines 212, 214 is changing state but since the LCR antenna 208, as previously described only radiates during such transitions in practice this may not be a significant limitation.

FIG. 4f shows yet another alternative for coupling a UWB transmission to mains power wiring which may be employed where a wired earth circuit or connection exists. In the illustrative example of FIG. 4f mains conductor 404 terminates in a ground spike 418 or other ground connection, for example a cold water pipe. To achieve a degree of isolation between a UWB transmitter connected to the mains wiring and ground an rf choke 420 may be included in the earth circuit immediately adjacent to the actual lower ground connection 418. Where there is a plurality of such direct earth connections an rf choke may be included in series immediately adjacent each one. The rf choke should be selected to have a high impedance to transmissions at frequencies within the bandwidth of the UWB transmitter but a low impedance at lower ground frequencies. In particular mains frequencies such as 50 Hz or 60 Hz. In practice a few turns in a relatively stiff earth wire adjacent its connection point to a conductor leading into the ground may be sufficient.

One or more of a number of known techniques may be employed to reduce the susceptibility of the UWB network to noise present on the mains power supply wiring. For example the UWB transmission frequency and/or bandwidth may be modified, optionally adaptively, for example by pulse shaping prior to transmission. For example the centre frequency/bandwidth may be adjusted to move the UWB transmission away from frequencies with high levels of interference. Additionally or alternatively impulse timing (spacing and/or duty cycle) may be adjusted, for example so that nulls in the comb frequency spectrum coincide with the peak power from interferers. Where necessary, coherent pulse combining (that is pre-detection), or even combining post-detection can be employed for additional processing gain. Related time-correlation techniques or other anti-jamming techniques such as CDMA coding of transmitted data may also be employed.

No doubt many other effective alternatives will occur to the skilled person. For example applications of the above-described techniques are not limited to domestic buildings but may also be employed in office accommodation and industrial buildings. Similarly, although the techniques have been described with reference to the single-phase supply usually found in domestic dwellings corresponding techniques may also be employed with the three-phase circuits more commonly found in industry.

In alternatives to the above described methods and apparatus the mains power cable-based UWB signal distribution may be replaced (or supplemented) by UWB signal distribution based upon an alternative building wiring system. Thus instead of (or additionally to) the one or two electrical conductors of a mains power supply, one or two conductors of a computer networking cable, such as a Cat 5 cable, or one or two conductors of a telephone cable may be employed to distribute the UWB signal. For the reasons already mentioned, the low-power ultra-wideband pulsed nature of the signal reduces the likelihood of interference to existing signals transported on these cables.

It will be understood that the invention is not limited to the described embodiments and encompasses modifications apparent to those skilled in the art lying within the spirit and scope of the claims appended hereto.

1. A method of distributing an ultrawideband (UWB) communications signal through a building, the method comprising:
generating a UWB signal; and
coupling the UWB signal to at least one electrical conductor of a mains power supply circuit of the building to distribute the UWB signal.

2. A method as any claim 1 further comprising:
generating a plurality of UWB signals at a plurality of UWB transmitters; and
coupling said plurality of UWB signals onto said electrical conductor at a plurality of different points within said building.

3. A method as claim 2 further comprising establishing a common timing between at least a subset of said UWB signals.

4. A method as claim 1, 2 or 3 further comprising receiving said UWB signal at a plurality of points within said building.

5. A method as claimed in any preceding claim and wherein said coupling comprises capacitative coupling.

6. A method as claimed in any preceding claim comprising coupling said UWB signal to two electrical conductors of said mains power supply circuit.

7. A method as claim 6 further comprising differentially driving said UWB signal onto said two conductors.

8. A method as claimed in claim 6 wherein said coupling comprises applying a current drive to said electrical conductors.

9. A method as claimed in any preceding claim wherein said coupling is performed at a central distribution point of said mains power supply circuit of said building.

10. A method as claimed in any preceding claim further comprising varying at least one of a frequency and bandwidth of said UWB signal to suppress interference.

11. A method as claimed in any preceding claim further comprising varying a timing of said UWB signal to suppress interference.

12. A data communications network configured to use the method of any preceding claim.

13. Apparatus for distributing an ultrawideband (UWB) communications signal trough a building, the apparatus comprising:
means for generating a UWB signal; and
means for coupling the UWB signal to at least one electrical conductor of a mains power supply circuit of the building to distribute the UWB signal.

14. A consumer electronics device incorporating the apparatus of claim 13.

15. A consumer electronics device as claimed in claim 13 wherein the consumer electronics device is mains powered.
